(19) United States
(12) Patent Application Publication
(10) Pub. No.: US 2008/0231694 A1
(43) Pub. Date: Sep. 25, 2008

(54) IMAGE PROCESSOR OF ENDOSCOPE SYSTEM

(75) Inventor: Takuma Ohtaki, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 12/052,030

(22) Filed: Mar. 20, 2008

(30) Foreign Application Priority Data
Mar. 23, 2007 (JP) 2007-076039

(51) Int. Cl. H04N 7/18

(52) U.S. Cl. 348/65; 348/E07.085

(57) ABSTRACT

An image processor of an endoscope system comprises an input connector and a determination unit. The input connector is used for connecting one of a video signal output device that outputs a video signal that includes a synchronization signal and a non-video signal output device that outputs a non-video signal that does not include the synchronization signal, to the image processor. The determination unit determines which of the video signal output device or the non-video signal output device is connected to the image processor through the input connector.

### BACKGROUND OF THE INVENTION

1. Field of the Invention

The present invention relates to an image processor of an endoscope system, and in particular, to an image processor that outputs an image signal corresponding to a non-video signal that does not includes a synchronization signal, to a monitor, etc., that presents (outputs) an image based on an image signal obtained by an electronic scope.

2. Description of the Related Art

An endoscope system that can connect to the video signal output device is proposed.

Japanese unexamined patent publication (KOKAI) No. H09-90238 discloses an endoscope system that connects to a video signal output device, and that outputs the video signal to a monitor that displays the image based on the image signal obtained by the electronic scope.

However, in that endoscope system, connection of a non-video signal output device that the non-video signal that does not include a synchronization signal outputs, is not considered.

### SUMMARY OF THE INVENTION

Therefore, an object of the present invention is to provide an image processor of an endoscope system, that can receive a non-video signal.

According to the present invention, an image processor of an endoscope system comprises an input connector and a determination unit. The input connector is used for connecting one of a video signal output device that outputs a video signal that includes a synchronization signal and a non-video signal output device that outputs a non-video signal that does not include the synchronization signal, to the image processor. The determination unit determines which of the video signal output device or the non-video signal output device is connected to the image processor through the input connector.

### BRIEF DESCRIPTION OF THE DRAWINGS

The objects and advantages of the present invention will be better understood from the following description, with reference to the accompanying drawings in which:

FIG. 1 is a construction diagram of the endoscope system; and

FIG. 2 shows an example of the first dual picture indication mode of the monitor, where the image based on the first image signal is displayed on the first display area and the image based on the second signal output from the multiplexer on the basis of the non-video signal from a heart-rate meter is displayed on the second display area.

### DESCRIPTION OF THE PREFERRED EMBODIMENTS

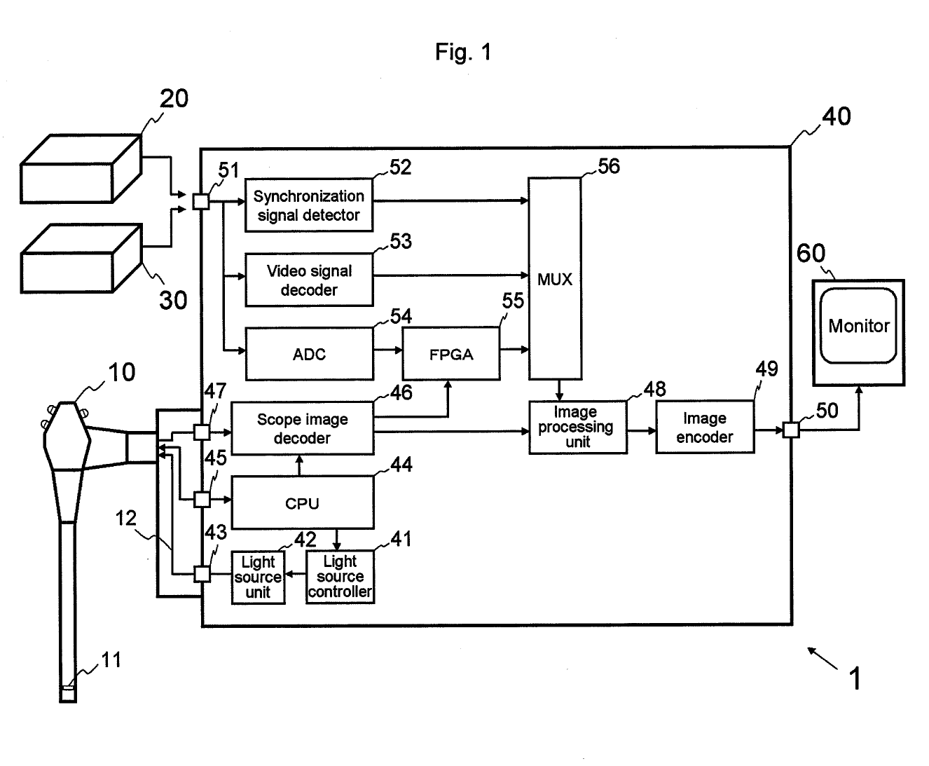

The present invention is described below with reference to the embodiment shown in the drawings. As shown in FIG. 1, an endoscope system 1 in the embodiment comprises an electronic scope 10, a video signal output device 20, a heart-rate meter 30, an image processor 40, and a monitor 60.

The electronic scope 10 has an insertion part and an operation-connection part. The insertion part is a flexible tube and is inserted into the body of a patient. The tip of the insertion part has an imaging unit 11 that has an imaging sensor and a control circuit for the imaging sensor. The operation-connection part has an operation key and is connected to the image processor 40.

During operation, the operator of the electronic scope 10 holds the operation-connection part and operates the operation key of the operation-connection part.

The electronic scope 10 has a light guide 12 that guides light from the image processor 40 to the tip of the insertion part through the operation-connection part.

The video signal output device 20 is an apparatus that outputs a video signal that includes a synchronization signal, as would a camcorder, etc.

The heart-rate meter 30 is an apparatus that measures heart rate and outputs a non-video signal. The non-video signal in the embodiment does not include a synchronization signal.

In the embodiment, either the video signal output device 20 or the heart-rate meter 30 is connected to the image processor 40 through an input connector 51.

It is explained that the heart-rate meter 30 is used as a non-video signal output device, however, another non-video signal output device may be used. For example, a bedside monitor (a life scope) that monitors an electrocardiogram, blood pressure, body heat, and a respirogram etc., are cited as non-video signal output devices.

The image processor 40 has a light-source controller 41, a light-source unit 42, a light-source connector 43, a CPU 44, a scope control connector 45, a scope image decoder 46, a scope image connector 47, an image-processing unit 48, an image encoder 49, a monitor connector 50, an input connector 51, a synchronization signal detector 52, a video signal decoder 53, an A/D converter 54, an FPGA (Field Programmable Gate Array) 55, and a multiplexer (MUX) 56.

The light-source controller 41 controls the light-source unit 42 that has an electric power supply and an igniter etc.

The light emitted from the light-source unit 42 is transmitted to the light guide 12 through the light-source connector 43.

The CPU 44 controls all parts of the electronic scope 10 and the image processor 40.

The scope image decoder 46 decodes the scope image signal from the electronic scope 10.

Within the image processor 40 are performed: a decoding operation for decoding the scope image signal obtained by the electronic scope 10; a conversion operation of the video signal from the video signal output device 20 or the non-video signal from the heart-rate meter 30 to the signal to be combined with the scope image signal; a combination operation for the scope image signal obtained by the electronic scope 10 and the video signal from the video signal output device 20 or the non-video signal from the heart-rate meter 30; and an image-processing operation of the combined signal to be displayed on the monitor 60.

The transmission of the control signal from the electronic scope 10 to the CPU 44, and the transmission of the control signal from the CPU 44 to the electronic scope 10 are performed through the scope control connector 45.

The transmission of the scope image signal from the electronic scope 10 to the scope image decoder 46 is performed through the scope image connector 47.

At the decoding operation of the scope image signal from the electronic scope 10 in the scope image decoder 46, the scope image signal is decoded by the image decoder 46. The decoded scope image signal is defined as a first image signal, in other words, the first image signal corresponds to the scope image signal. The scope image decoder 46 outputs a synchronization signal that is included in the first image signal to the FPGA 55. This synchronization signal is used for specifying the position for displaying the image based on the non-video signal on the monitor 60, by the FPGA 55.

Furthermore, the scope image signal that is decoded by the scope image decoder 46 is output to the image-processing unit 48 as the first image signal, and is then combined with the decoded video signal or a second image signal converted from the non-video signal, output from the multiplexer 56.

The transmission of the video signal from the video signal output device 20 or the non-video signal from the heart-rate meter 30 to the synchronization signal detector 52, the video signal decoder 53, and the A/D converter 54, is performed through the input connector 51.

In order to determine which of video signal output device 20 or heart-rate meter 30 is connected to the image processor 40 through the input connector 41, the synchronization signal detector 52 detects the synchronization signal in the output signal from the apparatus that is connected to the image processor 40 through the input connector 51, (i.e., the video signal output device 20 or the heart-rate meter 30), and then outputs the information as to whether a synchronization signal has been detected to the multiplexer 56, in the form of a synchronized detected pulse.

When a synchronization signal is detected, it is determined that the video signal output device 20 is in fact connected to the image processor 40 through the input connector 51, and the multiplexer 56 takes control of the transmission of the video signal, wherein the video signal is transmitted to the video signal decoder 53 through the input connector 51.

However, if the synchronization signal is not detected, it is determined that the heart-rate meter 30 (i.e. the non-video signal output device) is instead connected to the image processor 40 through the input connector 51, so that the multiplexer 56 takes control of the transmission of the non-video signal, wherein the non-video signal is transmitted to the A/D converter 54 through the input connector 51.

Accordingly, the determination of whether the video signal output device 20 or the heart-rate meter 30 is connected to the image processor 40 through the input connector 51 is performed by the synchronization signal detector 53 and the multiplexer 56 as a determination unit.

The video signal decoder 53 then decodes the video signal from the video signal output device 20 connected to the image processor 40 through the input connector 51 and outputs the decoded video signal to the multiplexer 56.

The A/D converter 54 performs the A/D conversion operation on the non-video signal from the heart-rate meter 30 connected to the image processor through the input connector 51.

The FPGA 55 generates the second image signal including the synchronization signal on the basis of the A/D-converted non-video signal and the synchronization signal in the first image signal, such that the contents of the non-video signal can be displayed on the monitor 60. In other words, the second image signal is cast into video format. The FPGA 55 outputs the second image signal to the multiplexer 56.

Furthermore, the FPGA 55 calculates a heart rate etc. based on the waveform of the heart rate within the non-video signal output from the heart-rate meter 30 when it generates the second image signal. The calculated heart rate is appended to the second image signal as character information so that it can be displayed on the monitor 60.

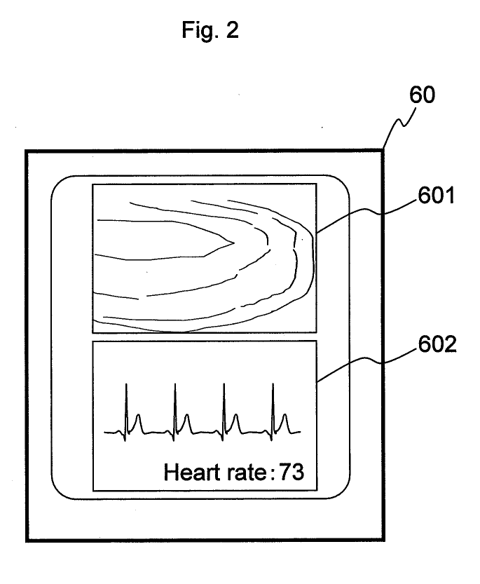

The second display area 602 in FIG. 2 illustrates how the value of the calculated heart rate is displayed with the waveform of the heart rate.

In other words, the FPGA 55 generates the second image signal on the basis of the non-video signal output from the heart-rate meter 30 under the condition where the value of the heart rate and the wave form of the heart rate can be displayed on the monitor 60.

The multiplexer 56 outputs the decoded video signal from the video signal decoder 53 to the image-processing unit 48, when the signal arriving at the input connector 51 includes a synchronization signal.

The multiplexer 56 outputs the second image signal from the FPGA 55 to the image-processing unit 48, when the input signal arriving at the input connector 51 does not include the synchronization signal.

The image-processing unit 48 combines the first image signal and either the decoded video signal or the second image signal, and outputs the combined signal to the image encoder 49.

Specifically, the image-processing unit 48 outputs a first combined signal of the first image signal and the decoded video signal to the image encoder 49 when the video signal output device 20 is connected to the image processor 40 through the input connector 51.

The image-processing unit 48 outputs a second combined signal of the first image signal and the second image signal to the image encoder 49 when the heart-rate meter 30 is connected to the image processor 40 through the input connector 51.

As an example of the combination, FIG. 2 depicts a first dual picture indication mode, where an image based on the first image signal that is decoded by the scope image decoder 46 and an image based on the signal output from the multiplexer 56 are arranged side-by-side style. In the example, the image based on the first image signal is displayed on the first display area 601 and the image based on the signal output from the multiplexer 56 is displayed on the second display area 602.

Furthermore, a second dual picture indication mode, where the image based on the signal output from the multiplexer 56 is downsized and arranged on the image based on the first image signal using picture-in-picture style, may be implemented.

Furthermore, an independent picture indication mode, where the image based on the first image signal and the image based on the signal output from the multiplexer 56 are displayed separately, may be implemented.

The image encoder 49 converts the combined signal to the video signal that can be displayed on the monitor 60. The video output from the image encoder 49 to the monitor 60 is performed through the monitor connector 50.

In addition, the combined video signal may instead be output to a video printer, etc.

The monitor 60 displays the combined image that has the image based on the scope image signal obtained by the electronic scope 10 and the image based on the video signal output from the video signal output device 20 or the image based on the non-video signal output from the heart-rate meter 30, on the basis of the combined signal output from the image encoder 49.

In the embodiment, the scope image signal obtained by the electronic scope 10 can be combined with the video signal output from the video signal output device 20 connected to the image processor 40, and with the non-video signal output from the non-video signal output device (the heart-rate meter 30 etc.) connected to the image processor 40, and then the combined image can be displayed on the monitor 60.

Because the connection between the video signal output device 20 or the non-video signal output device 20 and the image processor 40 are made through the same input connector 41, it is not necessary to increase the number of input connectors.

In the embodiment, one input connector 51 is set up in the image processor 40. However, a plurality of input connectors 51 and synchronization signal detectors 52 may be set up in the image processor 40 so that both the video signal output device 20 and the heart-rate meter 30 can be connected to the image processor 40 through the plurality of input connectors 51 at the same time.

In this case, in order to determine whether video signal output device 20 or heart-rate meter 30 is connected to the image processor 40 through each of the input connectors 51, the synchronization signal detector 52 detects the synchronization signal in the output signal from the apparatus that is connected to the image processor 40 through each of the input connectors 51.

When the video signal output device 20 and the heart-rate meter 30 are connected to the image processor 40 through the plurality of input connectors 51 and the synchronization signal detectors 52, either the video signal from the video signal output device 20 or the non-video output signal from the heart-rate meter 30 selected by the operator etc., is combined with the first image signal corresponding to the scope image signal obtained by the electronic scope 10.

Although the embodiment of the present invention has been described herein with reference to the accompanying drawings, obviously many modifications and changes may be made by those skilled in this art without departing from the scope of the invention.

The present disclosure relates to subject matter contained in Japanese Patent Application No. 2007-076039 (filed on Mar. 23, 2007) which is expressly incorporated herein by reference, in its entirety.

1. An image processor of an endoscope system comprising:
an input connector that is used for connecting at least one of a video signal output device that outputs a video signal that includes a synchronization signal and a non-video signal output device that outputs a non-video signal that does not include said synchronization signal, to said image processor; and
a determination unit that determines which of said video signal output device or said non-video signal output device is connected to said image processor through said input connector.

2. The image processor according to claim 1, further comprising an image-processing unit that outputs a signal corresponding to said video signal to an image output device that outputs an image based on a first image signal corresponding to a scope image signal obtained by an electronic scope that is connected to said image processor, when said determination unit determines that said video signal output device is connected to said image processor through said input connector;
wherein said image-processing unit outputs a second image signal corresponding to said non-video signal to said image output device, when said determination unit determines that said non-video signal output device is connected to said image processor through said input connector.

3. The image processor according to claim 2, wherein said image-processing unit outputs a first combined signal of said first image signal and said signal corresponding to said video signal to said image output device, when said determination unit determines that said video signal output device is connected to said image processor through said input connector; and
said image-processing unit outputs a second combined signal of said first image signal and said second image signal to said image output device, when said determination unit determines that said non-video signal output device is connected to said image processor through said input connector.

4. The image processor according to claim 3, further comprising an A/D converter that performs an A/D conversion operation on said non-video signal; and
a generation unit that generates said second image signal having a video format on the basis of said non-video signal A/D-converted by said A/D converter and outputs said second image signal to said image-processing unit.

5. The image processor according to claim 4, wherein said generation unit generates said second image signal on the basis of a synchronization signal in the first image signal.

6. The image processor according to claim 1, wherein said determination unit determines whether a signal output from an apparatus that is connected to said image processor through said input connector includes a synchronization signal, in order to determine which of said video signal output device or said non-video signal output device is connected to said image processor through said input connector.

7. An image processor of an endoscope system comprising a determination unit that determines which of a video signal output device that outputs a video signal that includes a synchronization signal or a non-video signal output device that does not include said synchronization signal is connected to said image processor through an input connector.
